(19) United States
(12) Patent Application Publication
(10) Pub. No.: US 2010/0135379 A1
(43) Pub. Date: Jun. 3, 2010

(54) METHOD AND SYSTEM FOR ENCODING AND DECODING FRAMES OF A DIGITAL IMAGE STREAM

(75) Inventors: Etienne Fortin, Saint-Basile-Le-Grand (CA); Nicholas Routhier, Candiac (CA)

Correspondence Address: Anglehart et al., Suite 258, 393 St-Jacques, Montreal, QC, H2Y 1N9, CA

(73) Assignee: Sensio Technologies Inc., Montreal (CA)

(21) Appl. No.: 12/326,875

(22) Filed: Dec. 2, 2008

(51) Int. Cl. H04N 7/26

(52) U.S. Cl. 375/240.01; 375/E07.2

(57) ABSTRACT

A method and a system for encoding and decoding a digital image frame. Metadata representative of a value of at least one component of at least one pixel of the frame is generated in the course of applying an encoding operation to the frame. A standard compression operation is then applied to the encoded frame, as well as to the metadata, in preparation for either transmission or recording. At the receiving end, both the encoded frame and its associated metadata undergo standard decompression, after which the metadata is used in the course of applying a decoding operation to the encoded frame for reconstructing the original frame.

### TECHNICAL FIELD

This invention relates to the field of digital image transmission and more specifically to a method and system for encoding and decoding frames of a digital image stream.

### BACKGROUND

When transmitting digital image streams, some form of compression (also referred to as encoding) is often applied to the image streams in order to reduce data storage volume and bandwidth requirements. For instance, it is known to use a quincunx or checkerboard pixel decimation pattern in video compression. Obviously, such compression leads to a necessary decompression (or decoding) operation at the receiving end, in order to retrieve the original image streams.

In commonly assigned US patent application publication 2003/0223499, stereoscopic image pairs of a stereoscopic video are compressed by removing pixels in a checkerboard pattern and then collapsing the checkerboard pattern of pixels horizontally. The two horizontally collapsed images are placed in a side-by-side arrangement within a single standard image frame, which is then subjected to conventional image compression (e.g. MPEG2) and, at the receiving end, conventional image decompression. The decompressed standard image frame is then further decoded, whereby it is expanded into the checkerboard pattern and the missing pixels are spatially interpolated.

Although the various levels of compression/encoding and decompression/decoding that digital image streams undergo in the course of transmission are necessary given the current standards for storage and broadcast (transport) of video sequences, problems inevitably arise in the form of loss of information and/or distortion. Various different techniques for these compression/encoding and decompression/decoding operations have been developed over the years and continue to be improved upon, with a particular goal being to reduce the inherent degree of data loss and/or image artifacts. However, there is still much room for improvement, particularly when it comes to increasing the quality level of the reconstructed image stream at the receiving end.

Consequently, there exists a need in the industry to provide an improved method and system for encoding and decoding digital image streams.

### SUMMARY

In accordance with a broad aspect, the present invention provides a method of encoding a digital image frame. The method includes generating metadata representative of a value of at least one component of at least one pixel of the frame in the course of applying an encoding operation to the frame.

In accordance with another broad aspect, the present invention provides a method of decoding an encoded digital image frame for reconstructing an original version of the frame. The method includes utilizing metadata in the course of applying a decoding operation to the encoded frame, wherein the metadata is representative of a value of at least one component of at least one pixel of the original version of the frame.

In accordance with yet another broad aspect, the present invention provides a system for processing frames of a digital image stream. The system includes a processor for receiving a frame of the image stream, the processor being operative to generate metadata representative of a value of at least one component of at least one pixel of the frame. The system also includes a compressor for receiving the frame and the metadata from the processor, the compressor being operative to apply a compression operation to the frame and to the metadata for generating a compressed frame and associated compressed metadata. The system includes an output for releasing the compressed frame and the compressed metadata.

In accordance with a further broad aspect, the present invention provides a system for processing compressed image frames. The system includes a decompressor for receiving a compressed frame and associated compressed metadata and for applying thereto a decompression operation in order to generate a decompressed frame and associated decompressed metadata. The system also includes a processor for receiving the decompressed frame and its associated decompressed metadata from the decompressor, the processor being operative to utilize the decompressed metadata in the course of applying a decoding operation to the decompressed frame for reconstructing an original version of the decompressed frame, wherein the decompressed metadata is representative of a value of at least one component of at least one pixel of the original version of the decompressed frame. The system further includes an output for releasing the reconstructed original version of the decompressed frame.

In accordance with another broad aspect, the present invention provides a processing unit for processing frames of a digital image stream, the processing unit operative to generate metadata representative of a value of at least one component of at least one pixel of at least one frame of the image stream in the course of applying an encoding operation to the frames of the image stream.

In accordance with yet another broad aspect, the present invention provides a processing unit for processing frames of a decompressed image stream, the processing unit operative to receive metadata associated with a decompressed frame and to utilize this metadata in the course of applying a decoding operation to the decompressed frame for reconstructing an original version of the decompressed frame, wherein the metadata is representative of a value of at least one component of at least one pixel of the original version of the decompressed frame.

### BRIEF DESCRIPTION OF THE DRAWINGS

The invention will be better understood by way of the following detailed description of embodiments of the invention with reference to the appended drawings, in which:

FIG. 1 is a schematic representation of a system for generating and transmitting a stereoscopic image stream, according to the prior art;

FIG. 2 illustrates a simplified system for processing and decoding a compressed image stream, according to the prior art;

FIGS. 3, 4 and 5 illustrate variations of a technique for preparing a digital image frame for transmission, according to non-limiting examples of implementation of the present invention;

FIG. 6 is a table of experimental data comparing the different PSNR (Peak Signal-to-Noise Ratio) results for the transmission of a digital image frame with and without metadata, according to a non-limiting example of implementation of the present invention;

FIG. 7 is a schematic illustration of the compatibility of the transmission technique of the present invention with existing video equipment;

FIG. 8 is a flow diagram of a frame encoding process, according to a non-limiting example of implementation of the present invention; and

FIG. 9 is a flow diagram of a compressed frame decoding process, according to a non-limiting example of implementation of the present invention.

### DETAILED DESCRIPTION

It should be understood that the expressions “decoded” and “decompressed” are used interchangeably within the present description, as are the expressions “encoded” and “compressed”. Furthermore, although examples of implementation of the invention will be described herein with reference to three-dimensional stereoscopic images, such as movies, it should be understood that the scope of the invention encompasses other types of video images as well.

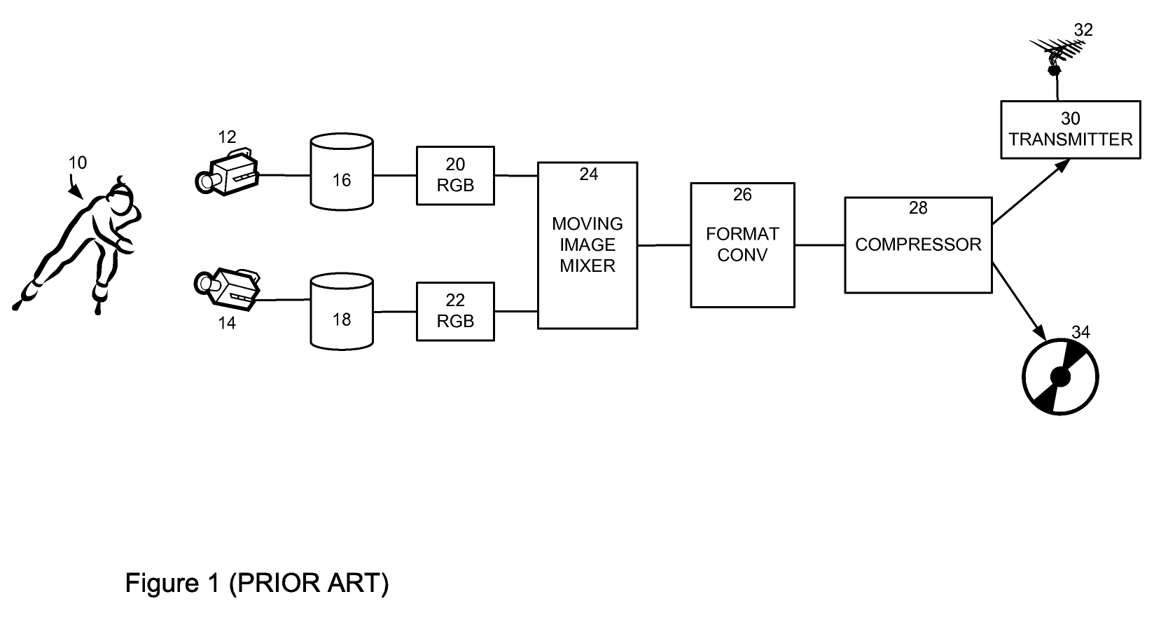

FIG. 1 illustrates an example of a system for generating and transmitting a stereoscopic image stream, according to the prior art. A first and a second source of image sequences represented by cameras 12 and 14 are stored into common or respective digital data storage media 16 and 18. Alternatively, image sequences may be provided from digitized movie films or any other source of digital picture files stored in a digital data storage medium or inputted in real time as a digital video signal suitable for reading by a microprocessor based system. Cameras 12 and 14 are shown in a position wherein their respective captured image sequences represent different views with a parallax of a scene 10, simulating the perception of a left eye and a right eye of a viewer, according to the concept of stereoscopy. Therefore, appropriate reproduction of the first and second captured image sequences would enable a viewer to perceive a three-dimensional view of scene 10.

Stored digital image sequences are then converted to an RGB format by processors such as 20 and 22 and fed to inputs of moving image mixer 24. Since the two original image sequences contain too much information to enable direct storage onto a conventional DVD or direct broadcast through a conventional channel using the MPEG2 or equivalent multiplexing protocol, the mixer 24 carries out a decimation process to reduce each picture's information. More specifically, the mixer 24 compresses or encodes the two planar RGB input signals into a single stereo RGB signal, which may then undergo another format conversion by a processor 26 before being compressed into a standard MPEG2 bit stream format by a typical compressor circuit 28. The resulting MPEG2 coded stereoscopic program can then be broadcasted on a single standard channel through, for example, transmitter 30 and antenna 32 or recorded on a conventional medium such as a DVD. Alternative transmission medium could be, for instance, a cable distribution network or the Internet.

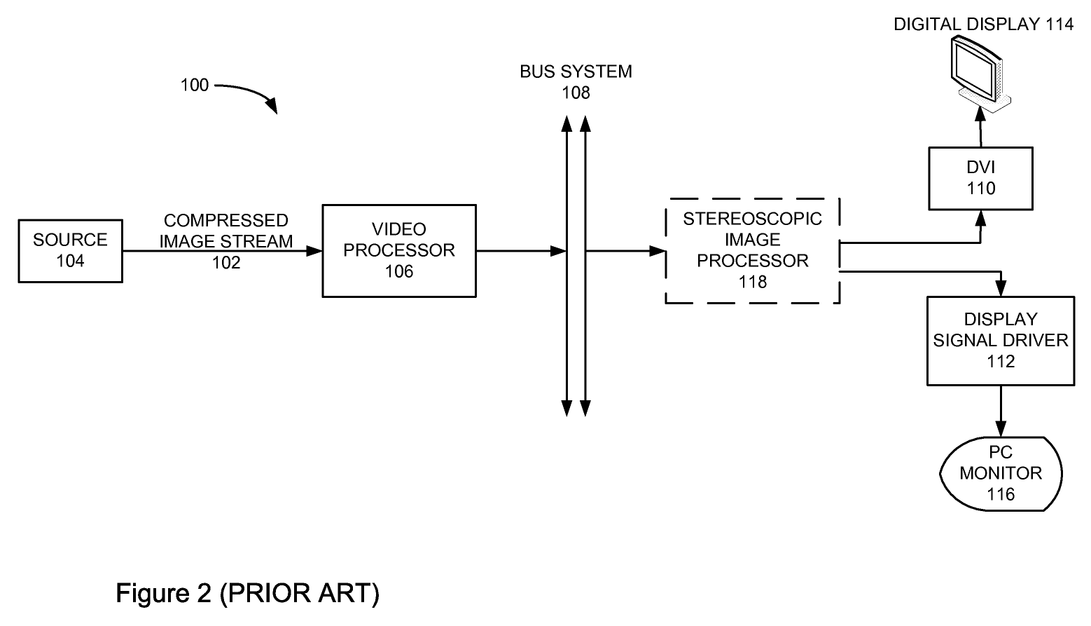

Turning now to FIG. 2, there is illustrated a simplified computer architecture 100 for receiving and processing a compressed image stream, according to the prior art. As shown, the compressed image stream 102 is received by video processor 106 from a source 104. The source 104 may be any one of various devices providing a compressed (or encoded) digitized video bit stream, such as for example a DVD drive or a wireless transmitter, among other possibilities. The video processor 106 is connected via a bus system 108 to various back-end components. In the example shown in FIG. 2, a digital visual interface (DVI) 110 and a display signal driver 112 are capable to format pixel streams for display on a digital display 114 and a PC monitor 116, respectively.

Video processor 106 is capable to perform various different tasks, including for example some or all video playback tasks, such as scaling, color conversion, compositing, decompression and deinterlacing, among other possibilities. Typically, the video processor 106 would be responsible for processing the received compressed image stream 102, as well as submitting the compressed image stream 102 to color conversion and compositing operations, in order to fit a particular resolution.

Although the video processor 106 may also be responsible for decompressing and deinterlacing the received compressed image stream 102, this interpolation functionality may alternatively be performed by a separate, back-end processing unit. In a specific, non-limiting example, the compressed image stream 102 is a compressed stereoscopic image stream 102 and the above-discussed interpolation functionality is performed by a stereoscopic image processor 118 that interfaces between the video processor 106 and both the DVI 110 and display signal driver 112. This stereoscopic image processor 118 is operative to decompress and interpolate the compressed stereoscopic image stream 102 in order to reconstruct the original left and right image sequences. Obviously, the ability of the stereoscopic image processor 118 to successfully reconstruct the original left and right image sequences is greatly hampered by any data loss or distortion in the compressed image stream 102.

The present invention is directed to a method and system for encoding and decoding frames of a digital image stream, resulting in an improved quality of the reconstructed image stream after transmission. Broadly put, when encoding a frame of the image stream in preparation for transmission or recording, metadata is generated, where this metadata is representative of a value of at least one component of at least one pixel of the frame. The frame and its associated metadata both then undergo a respective standard compression operation (e.g. MPEG2 or MPEG, among other possibilities), after which the compressed frame and the compressed metadata are ready for transmission to the receiving end or for recording on a conventional medium. At the receiving end, the compressed frame and associated compressed metadata undergo respective standard decompression operations, after which the frame is further decoded/interpolated at least in part on a basis of its associated metadata in order to reconstruct the original frame.

It is important to note that, upon encoding of the image frame, metadata may be generated for each pixel of the frame or for a subset of pixels of the frame. Any such subset is possible, down to a single pixel of the image frame. In a specific, non-limiting example of implementation of the present invention, metadata is generated for some or all of the pixels of the frame that are decimated (or removed) in the course of encoding the frame. In the case of generating metadata for only select ones of the decimated pixels of the frame, the decision to generate metadata for a particular decimated pixel may be taken on a basis of by how much a standard interpolation of the particular decimated pixel deviates from the original value of the particular pixel. Thus, for a predefined maximum acceptable deviation, if a standard interpolation of the particular decimated pixel results in a deviation from the original pixel value that is greater than the predefined maximum acceptable deviation, metadata is generated for the particular decimated pixel. Conversely, if the standard interpolation of the particular decimated pixel results in a deviation that is smaller than the predefined maximum acceptable deviation, that is if the quality of the standard interpolation of the particular decimated pixel is sufficiently high, no metadata need be generated for the particular decimated pixel.

Advantageously, by generating and transmitting/recording along with an encoded image frame metadata characterizing at least certain pixels of the original frame, where this metadata is very easily compressible by standard compression schemes (e.g. techniques used in MPEG4), it is possible to increase a quality level of the reconstructed frame at the receiving end without adding a significant burden to the bandwidth of the transmission or recording medium. More specifically, when encoding of a frame results in certain pixels of the frame being removed from the frame and thus not transmitted or recorded, the metadata generated for some or all of these missing pixels and accompanying the encoded frame eases and improves the process of filling in the missing pixels and reconstructing the original frame at the receiving end.

Obviously, within an image stream, it is possible that while certain frames of the stream may benefit from having associated metadata, others may not require the metadata. More specifically, if the standard interpolation applied at the time of decoding of an encoded version of a particular frame results in a deviation from the original particular frame that is considered acceptable (e.g. smaller than a predefined maximum acceptable deviation), then metadata need not be generated for the particular frame. Accordingly, within a compressed image stream that is transmitted or recorded with associated metadata, certain frames may have associated metadata while others may not, without departing from the scope of the present invention.

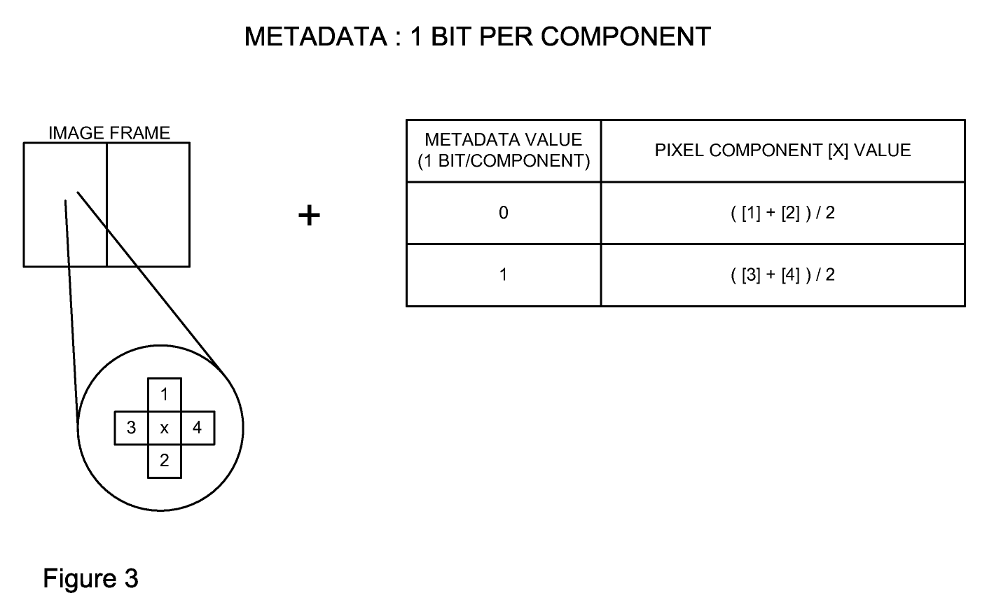

FIGS. 3, 4 and 5 illustrate variations of a technique for encoding a digital image frame, according to non-limiting examples of implementation of the present invention. In the examples shown, the digital image frame is a stereoscopic image frame that has undergone compression encoding such that the frame includes side-by-side merged images, as will be discussed in further detail below. In the course of this encoding, metadata is generated for at least some of the pixels that are decimated or removed from the frame.

It is important to note however that the technique of the present invention is applicable to all types of digital image streams and is not limited in application to any one specific type of image frames. That is, the technique may be applied to digital image frames other than stereoscopic image frames. Furthermore, the technique may be applied regardless of the particular type of encoding operation that is applied to the frames, whether it be compression encoding or some other type of encoding. Finally, the technique may even be applied if the digital image frames are to be transmitted/recorded without undergoing any further type of encoding or compression (e.g. transmitted/recorded as uncompressed data rather than JPEG, MPEG2 or other), without departing from the scope of the present invention.

In FIG. 3, there is illustrated the encoding of a digital image frame by generating one bit of metadata per component of selected decimated pixels of the frame. Thus, as the frame undergoes compression encoding, various pixels are decimated and metadata is generated for at least one of these decimated pixels. This metadata is representative of an approximate value of each component of the at least one decimated pixel, and is intended for compression and transmission with the frame. The metadata is generated by consulting a predefined metadata mapping table, where this table maps different possible metadata values to different possible pixel component values. Since in this example the metadata consists of a single bit per pixel component, the metadata value may be either “0” or “1”.

As shown in FIG. 3, the metadata for a particular decimated pixel X of the frame is generated on a basis of pixel component values of at least one of adjacent pixels 1, 2, 3 and 4 in the frame. More specifically, each possible metadata value is representative of a distinct approximate value for the respective component of pixel X, where these distinct approximate values for the respective component of pixel X take the form of distinct combinations of the component values of adjacent pixels in the frame. In the non-limiting example of FIG. 3, metadata value “0” is representative of a component value of (([1]+[2])/2), while metadata value “1” is representative of a component value of (([3]+[4])/2), where [1], [2], [3] and [4] are the respective component values of the adjacent pixels 1, 2, 3 and 4. Thus, when generating the 1 bit of metadata for each component of decimated pixel X, the value for each bit of metadata is set by determining which combination of adjacent pixel component values is closest to the actual value of the respective component of pixel X.

Assume for example that the pixels of the frame are in an RGB format, such that each pixel has three components and is defined by a vector of 3 digital numbers, respectively indicative of the red, green and blue intensity. Furthermore, within the frame, each pixel has adjacent pixels 1, 2, 3 and 4, each of which also has a respective red, green and blue component. When generating the metadata for decimated pixel X, one bit of metadata is generated for each of components Xr, Xg and Xb. Thus, the metadata for pixel X could be, for example, “010”, in which case the metadata values for Xr, Xg and Xb are “0”, “1” and “0”, respectively. These metadata values for Xr, Xg and Xb are set on a basis of predefined combinations of adjacent pixel component values, where the particular metadata value chosen for a specific component of decimated pixel X is representative of the combination that is closest in value to the actual value of that specific component. Taking for example the predefined combinations shown in FIG. 3, metadata “010” for pixel X assigns to the components Xr, Xg and Xb the following values, each one being an average of the respective component values of a pair of adjacent pixels:

Xr=([1r]+[2r])/2

Xg=([3g]+[4g])/2

Xb=([1b]+[2b])/2

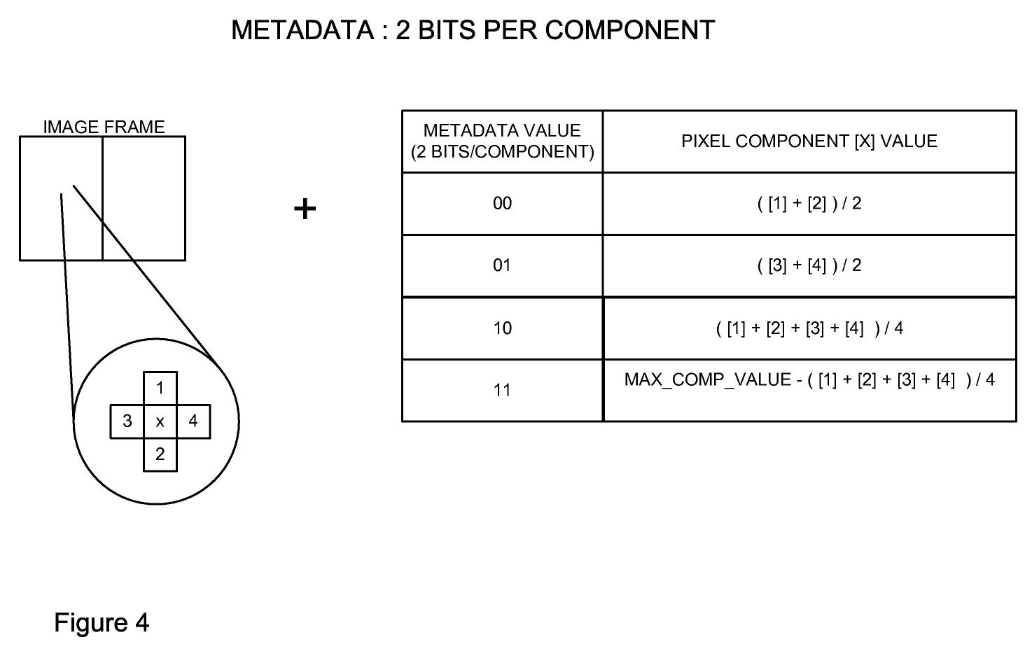

FIG. 4 illustrates a variation of the technique shown in FIG. 3, whereby the encoding of a digital image frame includes the generation of two bits of metadata per component of selected decimated pixels of the frame. The metadata value may thus be one of “00”, “01”, “10” and “11”. As in the case of 1 bit of metadata per component, each possible metadata value is representative of a distinct approximate value for the respective component of decimated pixel X, where these distinct approximate values take the form of distinct combinations of the component values of adjacent pixels in the frame. Obviously, as the number of bits of metadata available per component of each pixel increases, so do the number of possible combinations of adjacent pixel component values to be selected from when setting the metadata value for each component of decimated pixel X.

In the non-limiting example of FIG. 4, metadata value “00” is representative of a component value of (([1]+[2])/2), metadata value “01” is representative of a component value of (([3]+[4])/2), metadata value “10” is representative of a component value of (([1]+[2]+[3]+[4])/4) and metadata value “11” is representative of a component value of (MAX₁₃ COMP_VALUE−(([1]+[2]+[3]+[4])/4)), where [1], [2], [3] and [4] are the respective component values of the adjacent pixels 1, 2, 3 and 4 and MAX_COMP_VALUE is the maximum possible value of a pixel component within the frame (e.g. MAX_COMP_VALUE=255 for an 8-bit component). Thus, when generating the 2 bits of metadata for each component of decimated pixel X, the value for each 2 bits of metadata is set by determining which combination of adjacent pixel component values is closest to the actual value of the respective component of pixel X.

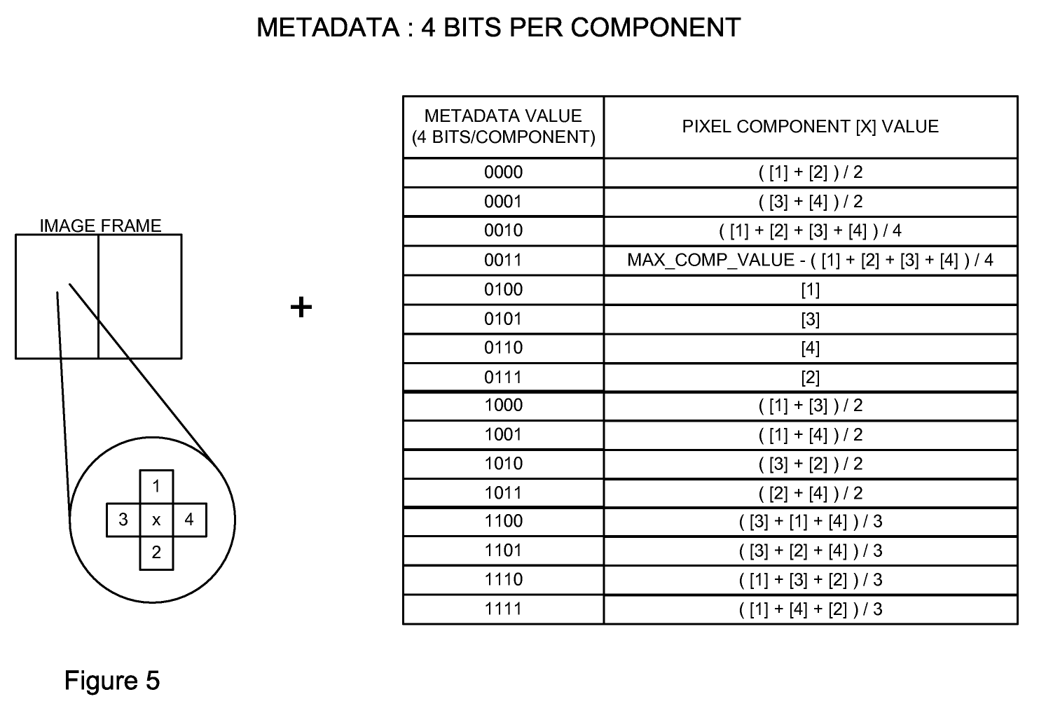

FIG. 5 illustrates another variation of the technique shown in FIG. 3, whereby the encoding of a digital image frame includes the generation of four bits of metadata per component of selected decimated pixels of the frame. The metadata value may thus be one of “0000”, “0001”, “0010”, “0011”, “0100”, “0101”, “0110”, “0111”, “1000”, “1001”, “1010”, “1011”, “1100”, “1101”, “1110” and “1111”. Each possible metadata value is representative of a distinct approximate value for the respective component of decimated pixel X, where this distinct approximate value is selected from sixteen (16) different combinations of the component values of one or more adjacent pixels in the frame.

In yet another possible variation of the technique shown in FIG. 3, the encoding of a digital image frame includes the generation of more than four bits of metadata per component of selected decimated pixels of the frame, for example five or eight bits, among many other possibilities. If the number of bits of metadata available per component is equal to the number of bits of each pixel component within the frame, the metadata generated for a particular decimated pixel is representative of the actual value of each component of the particular decimated pixel, rather than being representative of combinations of component values from adjacent pixels giving approximate values for each component. In the non-limiting example of a frame made up of 24-bit, 3-component pixels, the use of eight bits of metadata per component of selected decimated pixels would allow for the actual values of the components of the decimated pixels to be represented by the metadata, rather than simply approximations of these component values.

It is important to note that, regardless of the number of bits of metadata available per component of each decimated pixel X, various different predefined combinations of the adjacent pixel component values are possible and may be used to generate the metadata for the image frame, without departing from the scope of the present invention. Furthermore, it is also possible that the metadata for each decimated pixel X may be generated on a basis of the component values of non-adjacent pixels in the frame, or the component values of a combination of adjacent and non-adjacent pixels in the frame, without departing from the scope of the present invention.

In the above examples of FIGS. 3, 4 and 5, it has been described that, upon encoding of an image frame, metadata is generated for select decimated pixels of the image frame. Any such subset of the decimated pixels of the frame is possible, down to a single decimated pixel of the image frame. Obviously, since the generation and transmission of the metadata is intended to provide for an improved quality in the reconstructed image frame at the receiving end (after decompression), it follows that for a greater number of decimated pixels for which metadata is generated, as well as for a greater number of bits of metadata per component of each decimated pixel of the frame, there will be a greater increment of improved quality in the reconstructed image frame at the receiving end.

In a specific, non-limiting example, the metadata is generated only for those decimated pixels for which it has been found that a standard interpolation at the receiving end results in a deviation from the original pixel value that is greater than a predefined maximum acceptable deviation (i.e. the standard interpolation degrades the quality of the reconstructed frame). Thus, in the case of a decimated pixel for which a standard interpolation results in a deviation from the original pixel value that is smaller than the predefined maximum acceptable deviation (i.e. a good quality interpolation is possible at the receiving end), metadata need not be generated.

In a variant example of implementation of the present invention, in the course of applying an encoding operation to an image frame, metadata is generated for only select components of select decimated pixels of the frame. Thus, for a particular decimated pixel, metadata may be generated for at least one component of the particular pixel, but not necessarily for all of the components of the particular pixel. Obviously, it is also possible that no metadata be generated for the particular decimated pixel, in the case where the standard interpolation of the particular decimated pixel is of sufficiently high quality. In a specific, non-limiting example, the decision to generate metadata for a particular component of a decimated pixel may be taken on a basis of by how much a standard interpolation of the particular component of the decimated pixel deviates from the original value of the particular component. Thus, for a predefined maximum acceptable deviation, if a standard interpolation of the particular component of the decimated pixel results in a deviation from the original component value that is greater than the predefined maximum acceptable deviation, metadata is generated for the particular component of the decimated pixel. Conversely, if the standard interpolation of the particular component of the decimated pixel results in a deviation that is smaller than the predefined maximum acceptable deviation, that is if the quality of the standard interpolation of the particular component is sufficiently high, no metadata need be generated for the particular component of the decimated pixel.

In another variant example of implementation of the present invention, in the course of applying an encoding operation to an image frame, metadata is generated for each and every component of each and every pixel of the image frame that is decimated or removed from the frame during the encoding. The provision of this metadata in association with the encoded frame will thus provide for a simpler and more efficient interpolation of missing pixels upon decoding of the encoded frame at the receiving end. In a specific case of this variant example of implementation, when metadata is generated for each component of each decimated pixel of a frame, and the number of bits of metadata per component is equal to the actual number of bits of each pixel component in the frame, it is possible to obtain the greatest quality in the reconstructed image frame at the receiving end. This is because the metadata that accompanies the encoded frame and that is thus available at the receiving end represents the actual component values for every pixel that was decimated or removed from the frame upon compression encoding, without any approximation or interpolation.

In yet another variant example of implementation of the present invention, the generation of metadata for an image frame may include the generation of metadata presence indicator flags. Each flag would be associated with either the frame itself, a particular pixel of the frame or a specific component of a particular pixel of the frame and would indicate whether or not metadata exists for the frame, the particular pixel or the specific component. In the non-limiting example of a one-bit flag, the flag could be set to “1” to indicate the presence of associated metadata and to “0” to indicate the absence of associated metadata. In a specific, non-limiting example, upon generation of the metadata for a frame, a map of metadata presence indicator flags is also generated, where a flag may be provided for: 1) each pixel of the frame; 2) each one of a subset of pixels of the frame; 3) each one of a subset of components of each pixel of the frame; or 4) each one of a subset of components of a subset of pixels of the frame. A subset of pixels may include, for example, some or all of the pixels that are decimated from the frame during encoding. Upon decoding of an encoded frame having associated metadata, such metadata presence indicator flags would be particularly useful in the case where metadata was either only generated for certain ones of the pixels that were decimated from the frame during encoding or only generated for certain ones of the components of certain or all of the decimated pixels.

In a further variant example of implementation of the present invention, the generation of metadata for an image frame may include embedding in a header of this metadata an indication of the position of each pixel within the frame for which metadata has been generated. This header may further include, for each identified pixel position, an indication of the specific components for which metadata has been generated, as well as of the number of bits of metadata that is stored for each such component, among other possibilities.

Once all of the metadata for the image frame has been generated, the encoded frame and its associated metadata can be compressed by a standard compression scheme in preparation for transmission or recording. Note that the type of standard compression that is best suited to the frame may differ from the type of standard compression that is best suited to the associated metadata. Accordingly, the frame and its associated metadata may undergo different types of standard compression in preparation for transmission, without departing from the scope of the present invention. In a specific, non-limiting example, the stream of image frames may be compressed into a standard MPEG2 bit stream, while the stream of associated metadata may be compressed into a standard MPEG bit stream.

Once the encoded frame and its associated metadata have been compressed, they can be transmitted via an appropriate transmission medium to a receiving end. Alternatively, the compressed frame and its associated compressed metadata can be recorded on a conventional medium, such as a DVD. The metadata generated for the frames of an image stream thus accompany the image stream, whether the latter is sent over a transmission medium or recorded on a conventional medium, such as a DVD. In the case of transmission, a compressed metadata stream may be transmitted in a parallel channel of the transmission medium. In the case of recording, upon recording of the compressed image stream on a disk such as a DVD, the compressed metadata stream may be recorded in a supplementary track provided on the disk for storing proprietary data (e.g. user-data track). Alternatively, whether destined for transmission or recording, the compressed metadata may be embedded in each frame of the compressed image stream (e.g. in the header). Yet another alternative is to take advantage of a color space format conversion process that each frame must typically undergo prior to compression, in order to embed the metadata into the image stream. In a specific example, assuming that each frame of a stereoscopic image stream is converted from a RGB format to a YCbCr 4:2:2 color space prior to compression and transmission/recording of the image stream, the image stream may be formatted as a RGB 4:4:4 stream with the associated metadata stored in the additional storage space (i.e. extra bandwidth) available as a result of switching from the 4:2:2 format to the 4:4:4 format (while maintaining the main video data as YCbCr 4:2:2). Obviously, whether destined for transmission or recording, the frames of an image stream and the associated metadata may be coupled or linked together (or simply interrelated) by any one of various different solutions, without departing from the scope of the present invention.

When the frames of a compressed image stream along with the accompanying compressed metadata are either received over a transmission medium at a receiving end or read from a conventional medium by a player (e.g. DVD drive), the compressed frames and associated metadata are processed in order to reconstruct the original frames for display. This processing includes the application of standard decompression operations, where a different decompression operation may be applied to the compressed frames than to the associated compressed metadata. After this standard decompression, the frames may require further decoding in order to reconstruct the original frames of the image stream. Assuming that the frames were encoded at the transmitting end, upon decoding of a particular frame of the image stream, the associated metadata, if any, is used to reconstruct the particular frame. In a specific, non-limiting example, the metadata associated with a particular frame (or with specific pixels of the particular frame) is used to determine the approximate or actual values of at least some of the missing pixels of the particular frame, by consulting at least one metadata mapping table (such as the tables shown in FIGS. 3, 4 and 5) mapping metadata values to specific pixel component values. Depending on the number of bits of metadata per pixel, the specific pixel component values stored in the metadata mapping table are either the actual component values for the missing pixels or approximate component values in the form of combinations of component values from other pixels in the frame.

As discussed above, in a specific, non-limiting example, the metadata technique of the present invention may be applied to a stereoscopic image stream, where each frame of the stream consists of a merged image including pixels from a left image sequence and pixels from a right image sequence. In one particular example, compression encoding of the stereoscopic image stream involves pixel decimation and results in encoded frames, each of which includes a mosaic of pixels formed of pixels from both image sequences. Upon decoding, a determination of the value of each missing pixel is required in order to reconstruct the original stereoscopic image stream from these left and right image sequences. Accordingly, the metadata that is generated and accompanies the encoded stereoscopic frames is used at the receiving end to fill in at least some of the missing pixels when decoding the left and right image sequences from each frame.

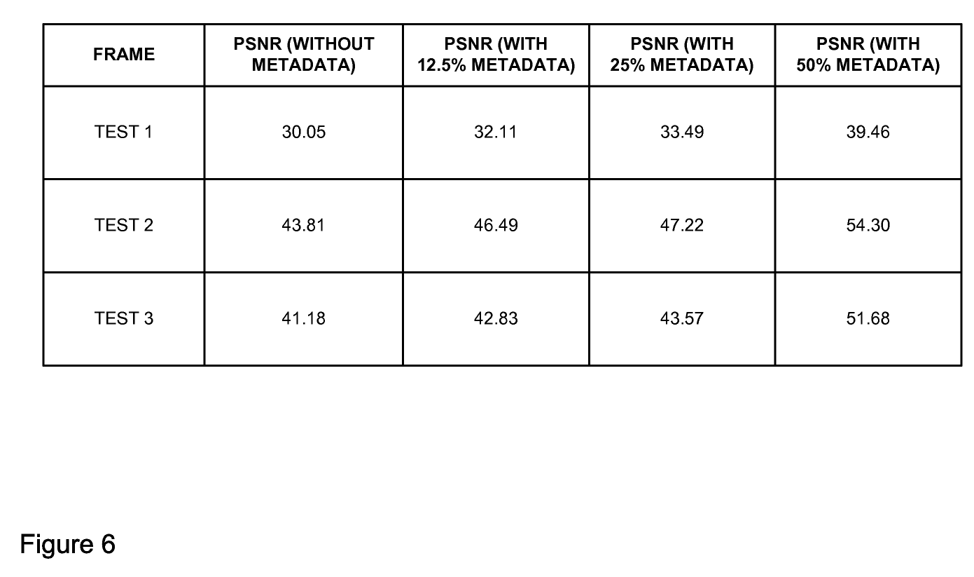

Continuing with the example of a stereoscopic image stream, FIG. 6 is a table of experimental data comparing the different PSNR (Peak Signal-to-Noise Ratio) results for the reconstruction of digital image frames encoded with and without metadata, according to a non-limiting example of implementation of the present invention. As is well known to those skilled in the art, the PSNR is a measure of the quality of reconstruction for lossy compression encoding, where in this particular case the signal is the original image frame and the noise is the error induced by the compression encoding. A higher PSNR reflects a higher quality reconstruction. The results shown in FIG. 6 are for 3 different stereoscopic frames (TEST1, TEST2 and TEST3), each of which is formed of 24-bit, 3-component pixels. These frames underwent compression encoding without the generation of metadata, with the generation of 12.5% of metadata (1 bit per component) for each decimated pixel, with the generation of 25% of metadata (2 bits per component) for each decimated pixel and with the generation of 50% of metadata (4 bits per component) for each decimated pixel. The results clearly show that, for each frame, the provision of metadata characterizing the decimated pixels of the frame allows for a higher, configurable PSNR upon reconstruction of the frame. More specifically, for each frame, the greater the number of bits of metadata provided per component of each decimated pixel, the greater the PSNR in the reconstructed image frame.

In terms of implementation, the functionality necessary for the metadata-based encoding and decoding techniques described above can easily be built into one or more processing units of existing transmission systems, or more specifically of existing encoding and decoding systems. Taking for example the system for generating and transmitting a stereoscopic image stream of FIG. 1, the moving image mixer 24 can be enabled to execute metadata generation operations in addition to its operations for compressing or encoding the two planar RGB input signals into a single stereo RGB signal. Taking for example the system for receiving and processing a compressed image stream of FIG. 2, the stereoscopic image processor 118 can be enabled to process received metadata in the course of decoding the encoded stereoscopic image stream 102 in order to reconstruct the original left and right image sequences. In these examples, the enabling of the moving image mixer 24 and the stereoscopic image processor 118 to generate metadata and process metadata, respectively, includes providing each of these processing units with accessibility to one or more metadata mapping tables, such as the tables illustrated in FIGS. 3, 4 and 5, which may be stored in memory local to or remote from each processing unit. Obviously, various different software, hardware and/or firmware based implementations of the metadata-based encoding and decoding techniques of the present invention are also possible and included within the scope of the present invention.

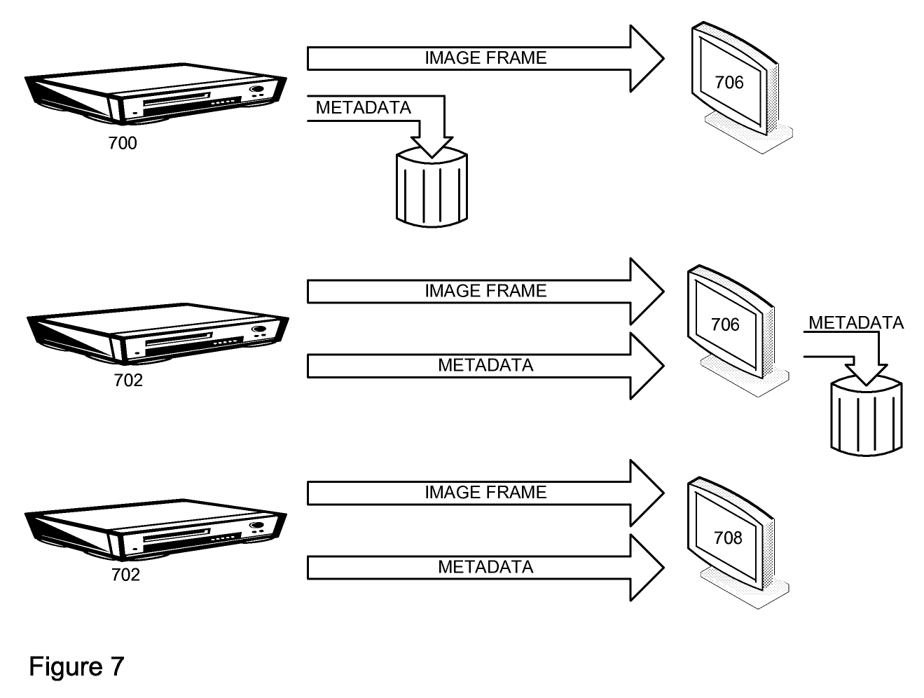

Advantageously, the metadata technique of the present invention allows for backward compatibility with existing video equipment. FIG. 7 illustrates a non-limiting example of this backward compatibility, where frames of a stereoscopic image stream have been compression encoded with metadata and recorded on a DVD. Upon reading of this DVD, a legacy DVD player 700 that does not recognize or handle metadata will simply ignore or throw out this metadata, transmitting only the encoded frames for decoding/interpolation and display. A DVD player 702 that is metadata savvy will transmit both the encoded frames and the associated metadata for decoding and display or, alternatively, will itself decode/interpolate the encoded frames at least partly on a basis of the associated metadata and will then transmit only the decoded frames for display. Similarly, a processing unit, such as for example the display itself, that is not capable to process the metadata will simply ignore the metadata and process only the encoded image frames. As seen, a legacy display 706 will throw out the metadata, decoding/interpolating the encoded frames without the metadata. A display 708 that is enabled to process the metadata will decode the encoded frames at least partly on a basis of this metadata.

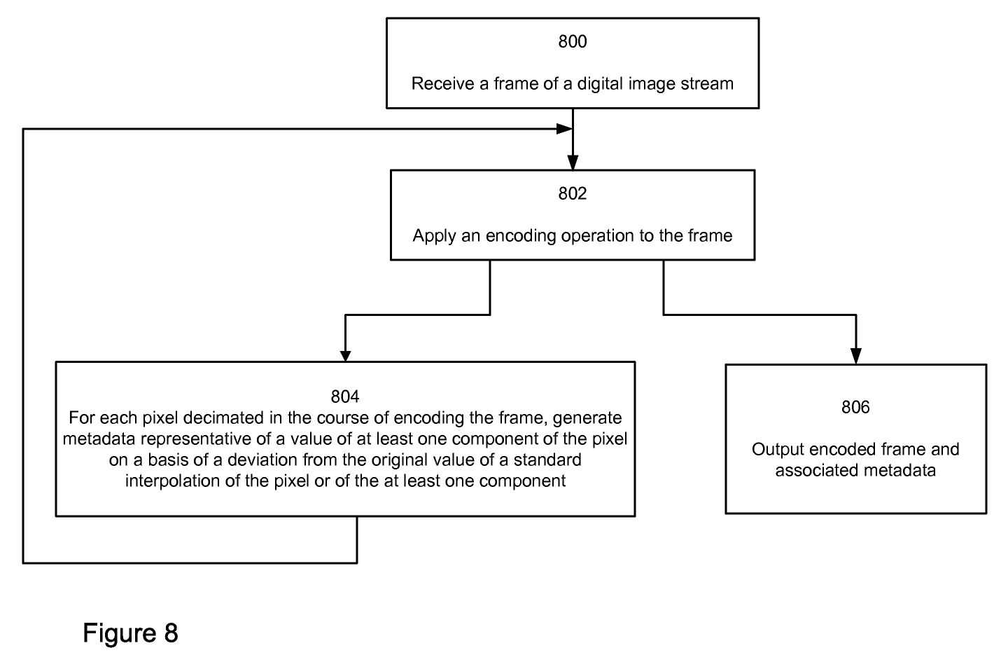

FIG. 8 is a flow diagram illustrating the metadata-based encoding process described above, according to a non-limiting example of implementation of the present invention. At step 800, a frame of a digital image stream is received. At step 802, the frame undergoes an encoding operation in preparation for transmission or recording, where this encoding operation involves the decimation or removal of certain pixels from the frame. At step 804, metadata is generated in the course of encoding the frame, where this metadata is representative of a value of at least one component of at least one pixel that is decimated during encoding. The decision to generate metadata for a particular decimated pixel or for a particular component of a decimated pixel is taken on a basis of by how much a standard interpolation of the particular pixel or component deviates from the original value of the particular pixel or component. At step 806, an encoded frame and its associated metadata are output, ready to undergo standard compression operations (e.g. MPEG or MPEG2) in preparation for transmission or recording.

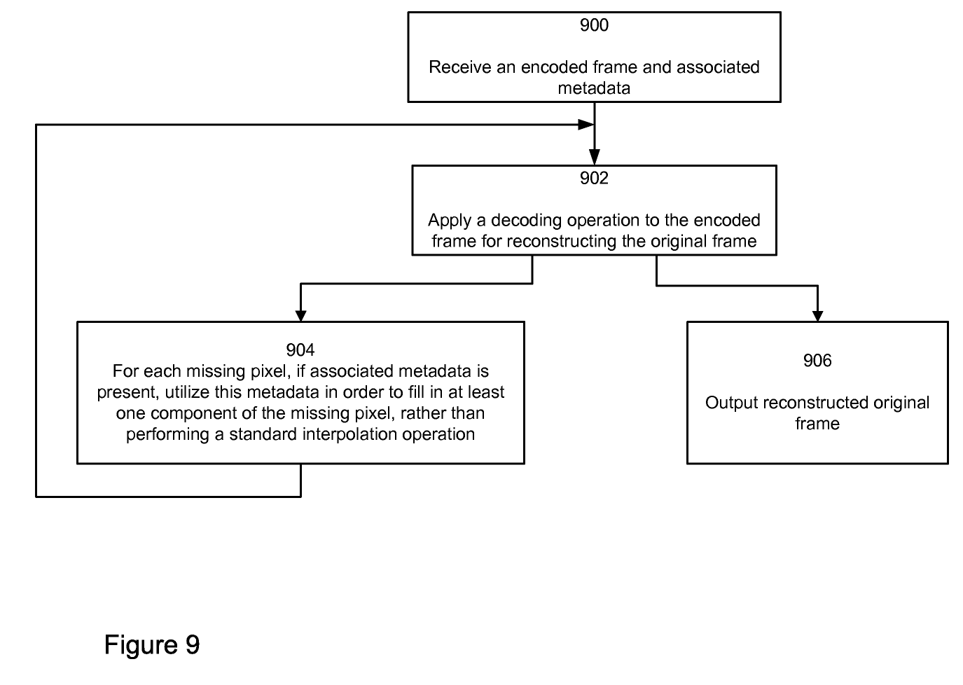

FIG. 9 is a flow diagram illustrating the metadata-based decoding process described above, according to a non-limiting example of implementation of the present invention. At step 900, an encoded image frame and its associated metadata are received, both of which may have previously undergone standard decompression operations (e.g. MPEG or MPEG2). At step 902, a decoding operation is applied to the encoded frame in order to reconstruct the original frame. At step 904, the associated metadata is utilized in the course of decoding the encoded frame, where this metadata is representative of a value of at least one component of at least one pixel that was decimated from the original frame during encoding. Thus, upon reconstruction of the original frame, if metadata is present for a particular missing pixel (i.e. a pixel that was decimated upon encoding of the original frame), this metadata is used to fill in the missing pixel or at least one component of this missing pixel, rather than performing a standard interpolation operation. At step 906, a reconstructed original frame is output, ready to undergo standard processing operations in preparation for display.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A method of encoding a digital image frame, said method comprising generating metadata representative of a value of at least one component of at least one pixel of the frame in the course of applying an encoding operation to the frame.

2. A method as defined in claim 1, wherein for each one of said at least one pixel, said metadata is representative of an approximate value of at least one component of the respective pixel.

3. A method as defined in claim 2, wherein said approximate value is a combination of at least one component value of at least one adjacent pixel in the frame.

4. A method as defined in claim 1, wherein for each one of said at least one pixel, said metadata is representative of an actual value of at least one component of the respective pixel.

5. A method as defined in claim 1, wherein said metadata is generated for a subset of pixels of the frame.

6. A method as defined in claim 5, wherein the subset of pixels includes at least one pixel that is removed from the frame as the frame undergoes the encoding operation.

7. A method as defined in claim 6, wherein the subset of pixels includes all of the pixels that are removed from the frame as the frame undergoes the encoding operation.

8. A method as defined in claim 7, wherein metadata is generated for each component of each pixel of the subset of pixels.

9. A method as defined in claim 5, wherein said method further comprises identifying each pixel of the subset of pixels of the frame for which metadata is generated.

10. A method as defined in claim 9, wherein generating metadata for the frame includes generating an indicator for at least one pixel of the frame, the indicator revealing whether or not metadata exists for the respective pixel.

11. A method as defined in claim 1, wherein said method further comprises identifying each component of each pixel of the frame for which metadata is generated.

12. A method as defined in claim 11, wherein generating metadata for the frame includes generating an indicator for at least one component of at least one pixel of the frame, each indicator revealing whether or not metadata exists for the respective component.

13. A method as defined in claim 1, wherein said metadata is generated for each pixel of the frame.

14. A method as defined in claim 6, wherein, for each pixel that is removed from the frame during the encoding operation, said method further comprises determining whether or not metadata is to be generated for the respective pixel.

15. A method as defined in claim 14, wherein for each pixel that is removed from the frame during the encoding operation, a standard interpolation of the respective pixel results in a deviation from an original value of the respective pixel, said determining including comparing the deviation of each pixel to a predefined maximum acceptable deviation.

16. A method as defined in claim 15, wherein if the deviation for a particular pixel is greater than the predefined maximum acceptable deviation, metadata is generated for the particular pixel.

17. A method as defined in claim 15, wherein if the deviation for a particular pixel is smaller than the predefined maximum acceptable deviation, metadata is not generated for the particular pixel.

18. A method as defined in claim 6, wherein, for each pixel that is removed from the frame during the encoding operation, said method further comprises determining whether or not metadata is to be generated for each component of the respective pixel.

19. A method as defined in claim 18, wherein for each pixel that is removed from the frame during the encoding operation, a standard interpolation of each component of the respective pixel results in a deviation from an original value of the respective component, said determining including comparing the deviation of each component of each pixel to a predefined maximum acceptable deviation.

20. A method as defined in claim 19, wherein if the deviation for a particular component is greater than the predefined maximum acceptable deviation, metadata is generated for the particular component.

21. A method as defined in claim 19, wherein if the deviation for a particular component is smaller than the predefined maximum acceptable deviation, metadata is not generated for the particular component.

22. A method as defined in claim 3, wherein said metadata includes a variable number of bits of data per pixel.

23. A method as defined in claim 22, wherein said metadata includes a variable number of bits of data per component of each one of said at least one pixel.

24. A method as defined in claim 23, wherein said metadata includes 1 bit of data per component of each one of said at least one pixel.

25. A method as defined in claim 23, wherein said metadata includes X≧2 bits of data per component of each one of said at least one pixel.

26. A method as defined in claim 4, wherein each pixel of the frame includes X bits of data and Y components, said metadata including X/Y bits of data per component of each one of said at least one pixel.

27. A method as defined in claim 1, wherein said generating metadata includes consulting a predefined metadata mapping table.

28. A method as defined in claim 27, wherein the predefined metadata mapping table maps metadata values to pixel component values.

29. A method as defined in claim 28, wherein the pixel component values of the predefined metadata mapping table are approximate pixel component values.

30. A method as defined in claim 29, wherein the pixel component values of the predefined metadata mapping table are in the form of combinations of at least one component value of at least one pixel of the frame.

31. A method as defined in claim 28, wherein the pixel component values of the predefined metadata mapping table are actual pixel component values.

32. A method as defined in claim 6, wherein the image frame is a stereoscopic image frame.

33. A method as defined in claim 32, wherein the encoding operation applied to the stereoscopic image frame is a compression encoding operation and includes merging together compressed left-eye and right-eye images.

34. A method as defined in claim 33, wherein the encoding of the stereoscopic image frame produces an encoded version of the frame that comprises side-by-side merged images.

35. A method as defined in claim 33, wherein the encoding of the stereoscopic image frame produces an encoded version of the frame that includes first and second pixel mosaics arranged adjacent one another, the first pixel mosaic being formed of the pixels from the left-eye image and the second pixel mosaic being formed of the pixels from the right-eye image.

36. A method of decoding an encoded digital image frame for reconstructing an original version of the frame, said method comprising utilizing metadata in the course of applying a decoding operation to the encoded frame, wherein the metadata is representative of a value of at least one component of at least one pixel of the original version of the frame.

37. A method as defined in claim 36, wherein the metadata is associated with a subset of pixels of the original version of the frame.

38. A method as defined in claim 37, wherein the subset of pixels includes at least one pixel that is missing from the encoded frame.

39. A method as defined in 37, wherein the subset of pixels includes all of the pixels that are missing from the encoded frame.

40. A system for processing frames of a digital image stream, said system comprising:
a. a processor for receiving a frame of the image stream, said processor being operative to generate metadata representative of a value of at least one component of at least one pixel of said frame;
b. a compressor for receiving said frame and said metadata from said processor, said compressor operative to apply a first compression operation to said frame and a second compression operation to said metadata for generating a compressed frame and associated compressed metadata;
c. an output for releasing said compressed frame and said compressed metadata.

41. A system as defined in claim 40, wherein said processor generates said metadata as said frame is undergoing an encoding operation.

42. A system as defined in claim 41, wherein said processor generates said metadata in the course of applying said encoding operation to said frame.

43. A system as defined in claim 41, wherein for each one of said at least one pixel of the frame, said metadata is representative of an approximate value of at least one component of the respective pixel.

44. A system as defined in claim 43, wherein said approximate value is a combination of at least one component value of at least one adjacent pixel in the frame.

45. A system as defined in claim 41, wherein for each one of said at least one pixel of the frame, said metadata is representative of an actual value of at least one component of the respective pixel.

46. A system as defined in claim 41, wherein said processor generates said metadata for a subset of pixels of the frame.

47. A system as defined in claim 46, wherein said subset of pixels includes at least one pixel that is removed from said frame as said frame undergoes said encoding operation.

48. A system as defined in claim 47, wherein said subset of pixels includes all of the pixels that are removed from said frame as said frame undergoes said encoding operation.

49. A system as defined in claim 41, wherein said processor generates said metadata for each component of each pixel of said subset of pixels.

50. A system as defined in claim 46, wherein said processor is further operative to identify each pixel of the subset of pixels of the frame for which metadata is generated.

51. A system as defined in claim 50, wherein said processor generates an indicator for at least one pixel of the frame, said indicator revealing whether or not metadata exists for the respective pixel.

52. A system as defined in claim 40, wherein said processor is further operative to identify each component of each pixel of the frame for which metadata is generated.

53. A system as defined in claim 52, wherein said processor generates an indicator for at least one component of at least one pixel of the frame, said indicator revealing whether or not metadata exists for the respective component.

54. A system as defined in claim 42, wherein for each pixel that is removed from said frame during said encoding operation, said processor is operative to determine whether or not metadata is to be generated for the respective pixel.

55. A system as defined in claim 54, wherein for each pixel that is removed from said frame during said encoding operation, a standard interpolation of the respective pixel results in a deviation from an original value of the respective pixel, said processor being operative to compare the deviation of each pixel to a predefined maximum acceptable deviation.

56. A system as defined in claim 55, wherein if the deviation for a particular pixel is greater than the predefined maximum acceptable deviation, said processor generates metadata for the particular pixel.

57. A system as defined in claim 55, wherein if the deviation for a particular pixel is smaller than the predefined maximum acceptable deviation, said processor does not generate metadata for the particular pixel.

58. A system as defined in claim 40, wherein said processor consults a predefined metadata mapping table in the course of generating metadata.

59. A system as defined in claim 58, wherein said predefined metadata mapping table maps metadata values to pixel component values.

60. A system as defined in claim 59, wherein the pixel component values of said predefined metadata mapping table are approximate pixel component values.

61. A system as defined in claim 60, wherein the pixel component values of said predefined metadata mapping table are in the form of combinations of at least one component value of at least one pixel of the frame.

62. A system as defined in claim 59, wherein the pixel component values of said predefined metadata mapping table are actual pixel component values.

63. A system for processing compressed image frames, said system comprising:
a. a decompressor for receiving a compressed frame and associated compressed metadata, said decompressor operative to apply a first decompression operation to said compressed frame and a second decompression operation to said compressed metadata for generating a decompressed frame and associated decompressed metadata;
b. a processor for receiving said decompressed frame and its associated decompressed metadata from said decompressor, said processor being operative to utilize said decompressed metadata in the course of applying a decoding operation to said decompressed frame for reconstructing an original version of said decompressed frame, wherein said decompressed metadata is representative of a value of at least one component of at least one pixel of said original version of said decompressed frame;
c. an output for releasing said original version of said decompressed frame.

64. A processing unit for processing frames of a digital image stream, said processing unit operative to generate metadata representative of a value of at least one component of at least one pixel of at least one frame of the image stream in the course of applying an encoding operation to the frames of the image stream.

65. A processing unit for processing frames of a decompressed image stream, said processing unit operative to receive metadata associated with a decompressed frame and to utilize said metadata in the course of applying a decoding operation to said decompressed frame for reconstructing an original version of said decompressed frame, wherein said metadata is representative of a value of at least one component of at least one pixel of the original version of said decompressed frame.
